(19) United States
(12) Patent Application Publication
(10) Pub. No.: US 2026/0369045 A1
(43) Pub. Date: Nov. 19, 2026

(54) SCALABLE ADAPTIVE FAILURE ESTIMATION FOR VISION-LANGUAGE-ACTION MODELS

(71) Applicant: Toyota Research Institute, Inc., Los Altos, CA (US)

(72) Inventors: Qiao Gu, Toronto (CA); Yuanliang Ju, Toronto (CA); Shengxiang Sun, Toronto (CA); Igor Gilitschenski, Toronto (CA); Haruki Nishimura, Sunnyvale, CA (US); Mikhal ltkina, Palo Alto, CA (US); Florian Shkurti, Toronto (CA)

(73) Assignees: Toyota Research Institute, Inc., Los Altos, CA (US); Toyota Jidosha Kabushiki Kaisha, Toyota-shi, Aichi-ken (JP); The Governing Council of the University of Toronto, Toronto, ON (CA)

(21) Appl. No.: 19/639,646

(22) Filed: Apr. 6, 2026

Related U.S. Application Data
(60) Provisional application No. 63/806,272, filed on May 15, 2025.

(51) Int. Cl. G06V 10/776; G06N 3/04; G06V 10/82

(52) U.S. Cl. CPC G06V 10/776; G06N 3/04; G06V 10/82

(57) ABSTRACT

An apparatus for detecting a failure by a vision-language-action (VLA) model. One embodiment of an apparatus includes one or more processors coupled to one or more memories and configured to: extract features from one or more layers of a vision-language-action (VLA) model; predict a failure score by processing the features; determine a time-varying threshold for detecting a failure by the VLA model; detect the failure based on the failure score exceeding the time-varying threshold; and perform an action in response to detecting the failure.

### CROSS-REFERENCE TO RELATED APPLICATIONS

This application claims the benefit of and priority to U.S. Provisional Patent Application No. 63/806,272, filed on May 15, 2025, the entire contents of which are hereby incorporated by reference.

### TECHNICAL FIELD

Embodiments described herein generally relate to detecting a failure by a vision-language-action (VLA) model.

### BACKGROUND

Artificial intelligence is a concept for simulating human intelligence, where machine learning allows an algorithm (e.g., a model), such as an artificial intelligence algorithm, to learn from, and make decisions based on, data without being deterministically programmed for making such decisions. A machine learning model includes a plurality of layers of parameters that are used to predict an output given an input. The machine learning model may be trained, such that the parameter weights of the model may be optimized to enable the model to provide or predict an accurate output given the input. Although there have been technological advancements over the years related to machine learning models and training of machine learning models, challenges still exist. Accordingly, improved systems, apparatuses, and/or methods of machine learning and/or machine learning model training are desired.

### SUMMARY

Systems, apparatuses, and methods for detecting a failure by a vision-language-action (VLA) model are described. One embodiment of an apparatus includes one or more processors coupled to one or more memories and configured to: extract features from one or more layers of a vision-language-action (VLA) model; predict a failure score by processing the features; determine a time-varying threshold for detecting a failure by the VLA model; detect the failure based on the failure score exceeding the time-varying threshold; and perform an action in response to detecting the failure.

In another embodiment, a method includes: extracting features from one or more layers of a vision-language-action (VLA) model; predicting a failure score by processing the features; determining a time-varying threshold for detecting a failure by the VLA model; detecting the failure based on the failure score exceeding the time-varying threshold; and performing an action in response to detecting the failure.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 is an illustration of internal features of a vision-language-action (VLA) model, according to embodiments described herein;

FIG. 2 is an illustration of a process flow for detecting a failure by a VLA model, according to embodiments described herein;

FIGS. 3A, 3B, 3C, 3D, 3E, 3F, 3G, 3H, 3I, and 3J include tables of information or data related to detecting a failure by a VLA model, according to embodiments described herein;

FIG. 4 is a block diagram illustrating components of an example ML model system, according to embodiments described herein;

FIG. 5 is a flow chart depicting an example process for detecting a failure by a VLA model, according to embodiments described herein; and

FIG. 6 is a block diagram illustrating computing hardware utilized in one or more devices for implementing various processes and systems, according to embodiments described herein.

### DETAILED DESCRIPTION

Certain embodiments of the present disclosure provide apparatuses, methods, processing systems, and computer-readable mediums for detecting a failure by a vision-language-action (VLA) model.

In robot learning, a VLA model (also referred to herein as a VLA) is a multimodal foundation model that integrates vision, language, and actions. For example, given an input image (or video) of a robot's surroundings and a text instruction, a VLA model outputs low-level robot actions that can be executed to accomplish a requested task. While VLA models have shown promising robotic behaviors across a diverse set of manipulation tasks, they achieve limited success rates when deployed on novel tasks out of the box (e.g., “unseen” during training). To allow these policies to safely interact with their environments, a failure detector may be used to provide a timely alert such that the robot can stop, backtrack, or ask for help. However, existing failure detectors are trained and tested only on one or a few specific tasks, while generalist VLA models (e.g., used for tasks including not only such specific tasks but also other unseen tasks) require the detector to generalize and detect failures also in unseen tasks and novel environments. Certain embodiments of the present disclosure address the multitask failure detection problem described above, and introduce a failure detector for generalist robot policies such as VLA models.

Through observation and analysis of the VLA model feature space, it was found that VLA models have sufficient high-level knowledge about task success and failure, which is generic across different tasks. Based on this insight, a scalable adaptive failure estimation model described herein is configured to learn from VLA model internal features and predict a single scalar indicating the likelihood of task failure. The scalable adaptive failure estimation model described herein is trained on both successful and failed rollouts, and is evaluated on unseen tasks. The scalable adaptive failure estimation model described herein is compatible with different policy architectures, and was tested on OpenVLA, π₀, and π₀-FAST in both simulated and real-world environments. The scalable adaptive failure estimation model described herein was compared with diverse baselines and shown to achieve state-of-the-art failure detection performance and a favorable trade-off between accuracy and detection time using conformal prediction.

Scaling up robot manipulation datasets has enabled the development of large VLA models, which are generalist manipulation policies that can follow language instructions and accomplish a wide range of tasks. However, when VLA models are (e.g., directly) deployed on unseen tasks without collecting additional demonstrations and finetuning the model, they still suffer from limited success rates and a wide range of failure modes. For example, in certain evaluations, while VLA models achieved success rates of 80-90% on seen tasks, their performance on unseen tasks dropped to 30-60% out of the box. To safely and reliably deploy VLA policies in the real world, it is important to promptly detect their potential failures.

Existing failure detection methods train a separate failure detector for each task, and evaluate the detector only on that task. While these methods work well for specialist policies, they do not suit generalists like VLA models. VLA models are designed to accomplish diverse tasks and may frequently encounter novel task instructions and unseen environments during deployment. In such cases, it is impractical to exhaustively collect rollouts and train a failure detector for every new task. Some existing methods introduce task-generic failure detectors, but they either require sampling multiple actions or need to query a large VLM (vision language model), which poses significant inference overhead for VLA models in the real world.

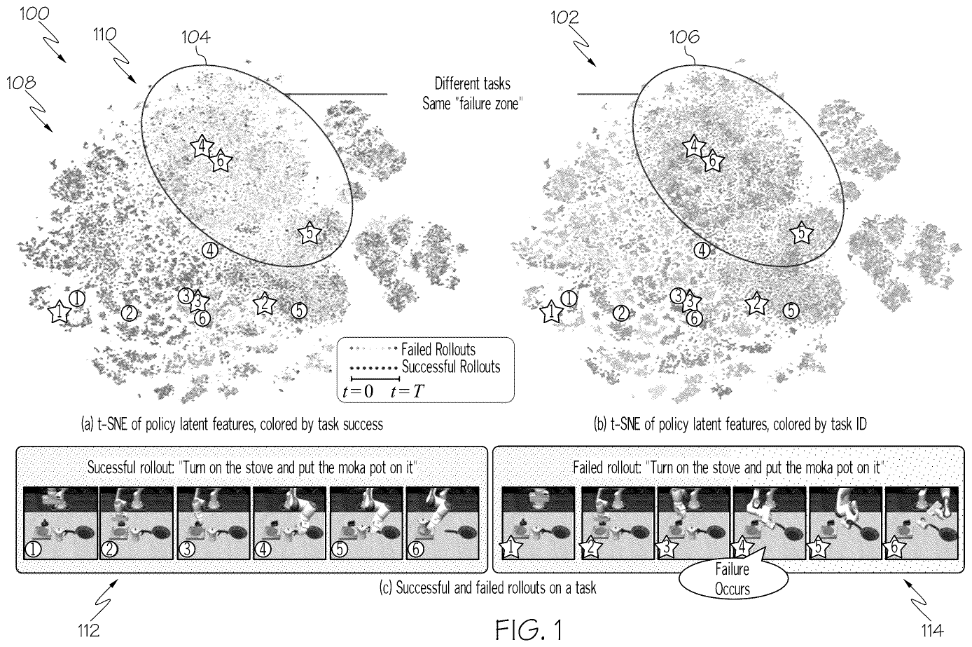

Certain embodiments of the present disclosure mitigate the multitask failure detection problem described above. These embodiments evaluate the failure detection performance of a VLA policy without collecting rollouts or finetuning the failure detector on unseen tasks. Certain internal features of VLA models capture high-level knowledge about task success and failure, such as illustrated in FIG. 1. For example, failed rollouts occupy a distinct region (“failure zone”) in the VLA model feature space, and this separation of region in the VLA model feature space remains consistent across different tasks.

The scalable adaptive failure estimation model described herein provides a scalable failure estimation method or system that scales across diverse tasks for generalist policies like VLA models. The scalable adaptive failure estimation model described herein takes in a VLA model's internal features and regresses them to a scalar (e.g., a single scalar) indicating the likelihood of failure. By training on successful and failed rollouts of multiple tasks, the scalable adaptive failure estimation model learns to identify task-generic representations for failure detection. To determine the threshold for failure detection, a functional conformal prediction (CP) framework is adopted, and the prediction band is calibrated on the seen tasks.

Certain failure detection experiments were conducted on OpenVLA, π₀, and π₀-FAST, in both simulation and the real world. For evaluation, diverse baseline failure detection methods were adapted from certain LLM (large language model) learning methods and robot learning methods onto VLA models. The scalable adaptive failure estimation model described herein and baselines were evaluated on both trained (seen) tasks and a set of held-out (unseen) tasks. These experiments showed that the scalable adaptive failure estimation model of the present disclosure outperforms other existing baselines and achieves the best trade-off between accuracy and timeliness for failure detection. The technical beneficial advantages of the embodiments of the present disclosure are as follows: (1) based on the VLA feature space, across different task instructions and environments, the internal features of a VLA model distinctly separate successful and failed rollouts; (2) the scalable adaptive failure estimation model described herein provides a multitask failure detector designed for generalist robot policies, where the model, by operating on latent features, training on multiple tasks, and using conformal prediction methods, provides generalization capabilities in detecting failures on unseen tasks; (3) experiments, including evaluation of the scalable adaptive failure estimation model described herein and diverse baselines on several large VLA models in both simulation and the real world, show that scalable adaptive failure estimation model of the present disclosure outperforms the baselines and achieves improved performance in failure detection.

Recent advances in large-scale machine learning and the availability of extensive robot demonstration datasets have paved the way for VLA models. These generalist robotic policies are initialized from pretrained large-scale VLMs, and thus inherit the ability to understand diverse semantic concepts from both images and language. In some cases, the VLA models are augmented with an action head that produces continuous control signals, through per-step binning, diffusion networks, or frequency-space tokenization. These VLA models are then trained on vast robotic datasets covering a wide array of tasks. As a result, VLA models can successfully perform familiar tasks in new environments and even tackle previously unseen tasks when provided with novel language instructions. Nevertheless, significant variability in real-world deployments and the challenging domain gaps between training and testing environments continue to hinder VLA model performance. Certain existing VLA models achieve success rates between 30% and 60% when evaluated out-of-the-box on real robots with unseen task instructions. These limitations highlight the need for robust multitask failure detection methods tailored to generalist VLA models.

Monitoring failures is critical when deploying robotic policies in real-world environments, as even minor errors can result in hazardous conditions. Certain existing methods of failure detection in robot learning can be broadly divided into unsupervised out-of-distribution (OOD) detection and supervised failure detection. OOD detection-based methods treat successful executions as the in-domain baseline and consider any deviation from this norm as a failure. However, the assumption that any unseen scenario constitutes a failure is overly restrictive for generalist VLAs, which may frequently encounter unseen tasks at test time. These unseen tasks may be different from the in-domain training data but should not be simply treated as failures. The scalable adaptive failure estimation model described herein provides a supervised failure detection, leveraging both successful and failed rollouts to train a failure classifier. Unlike existing methods that train and calibrate separate classifiers per task, the scalable adaptive failure estimation model described herein uses a single unified failure detector and works effectively on generalist policies like VLA models. Some existing methods explore multitask failure detection by designing action consistency scores or instruction-finetuning of a VLM model, but these existing methods require either sampling multiple actions or querying a large VLM, which poses significant overhead for controlling robots in real time.

Certain existing failure detection failures were systematically evaluated, including OOD detection-based approaches, smoothness-based techniques, and consistency-based strategies. Their experiments indicate that the best performance was achieved by LogpZO, which learns a proxy for the likelihood of the data in the observation embedding space using flow matching. However, their evaluation is limited to only single-task policies, and evaluation in the multitask setting shows that the LogpZO method suffers from overfitting to the training tasks.

Although LLMs and VLMs have demonstrated remarkable understanding and generative capabilities across various tasks, they are prone to producing hallucinated responses. Numerous methods have been developed for uncertainty quantification (UQ) in LLMs and VLMs. Token-level uncertainty quantification methods estimate uncertainty by analyzing the probability distribution over each generated token to assess the likelihood of an entire response. Semantic-similarity methods generate multiple responses to the same query and evaluate their semantic alignment; a higher variance among responses typically signals low confidence. Since VLA models share the generative nature and transformer architecture of LLMs or VLMs, these UQ methods may be adapted to the VLA models as baselines and evaluation of their performance on failure detection may be performed. Such UQ baselines may be used as a proxy for failure detection, assuming that when a policy becomes uncertain about its actions, it will have a higher probability of failing the task. Certain existing methods use the internal latent space of LLMs for hallucination detection. These methods train a classifier on internal latent features to distinguish between truthful and hallucinated outputs. This approach has proven to be simple, efficient, and effective for UQ in LLMs.

### Embodiments Related to Scalable Adaptive Failure Estimation for Vision-Language-Action Models

Certain embodiments of the present disclosure may detect when a robot policy fails during task execution. Specifically, a multitask failure detector that performs well when generalist VLAs encounter novel tasks at inference time. Aₜ timestep t, a VLA may be given an input observation oₜ, including image data (e.g., RGB images), natural language instruction, and current robot state, and output a control signal Aₜ=[aₜ, aₜ₊₁, . . . , aₜ+H−1], which is a chunk of actions for the next H timesteps. The first H′(H′≤H) actions in Aₜ are executed, and then the VLA replans a new action sequence A_{t+H′} at time t+H′. The internal embedding vector within the VLA at time t may be denoted as eₜ. Some VLAs may also decode a series of m tokens

$${W}_{t} = [ {W}_{t}^{1} , … , {w}_{t}^{m} ]$$

before converting them into the actual action vector. To train and evaluate failure detection models, the VLA may be run on different tasks in simulation or the real world, to collect the rollout trajectory τᵢ={(oₜ, eₜ, Wₜ, Aₜ)}_{t=0, H′, . . . ,nH′} with time duration T=nH′, and annotate each rollout with a failure label yᵢ(yᵢ=1 if the robot fails to accomplish the task and yᵢ=0 if the robot succeeds). For training, only the trajectory-level annotation yᵢ was used, and knowing the exact timestep when the policy starts to fail was not required. A failure detector may receive the rollout information up to time t and predict a failure score Sₜ, indicating the likelihood of task execution failure at time t. If sₜ exceeds a threshold δₜ, a failure flag is raised, and then either the task execution is aborted or a human monitor will step in and take over the control. In certain embodiments, conformal prediction is used to calibrate the threshold δₜ.

In the experiments that were conducted, all tasks were split into seen and unseen subsets, where rollouts from seen tasks were used for training Dₜᵣₐᵢₙ and validation Dₑᵥₐₗ₋ₛₑₑₙ, and all rollouts from unseen tasks Dₑᵥₐₗ₋ᵤₙₛₑₑₙ were reserved for testing the cross-task generalization ability of failure detectors. Failure detectors were trained on Dₜᵣₐᵢₙ, and evaluated on Dₑᵥₐₗ₋ₛₑₑₙ for hyperparameter tuning and in-domain performance, and tested on Dₑᵥₐₗ₋ᵤₙₛₑₑₙ for out-of-distribution generalization.

VLAs process multi-modal inputs and extract rich semantic information in their internal feature space. These features may also capture the high-level and abstract knowledge about task execution success/failure, by separating features from successful/failed rollouts into different regions. This was analyzed by visualizing the VLA features (as seen in FIG. 1), where the internal features were plotted from π₀-FAST when running the LIBERO-10 benchmark.

FIG. 1 illustrates the internal features of a VLA, which capture high-level information about task success and failure. When the VLA is failing, the features, even those from different tasks, fall into the same “failure zone” (see 104, 106 of FIG. 1). The failure zones 104, 106 enable the scalable adaptive failure estimation model described herein may use this information to enable an efficient multitask failure detection that is based on VLA internal features, where such detection can be generalized to unseen tasks. Plot 100 visualizes the latent features of π₀-FAST on LIBERO-10 using t-SNE (t-Distributed Stochastic Neighbor Embedding). For successful rollouts, features 108 are shown in a first shade. For failed rollouts, features 110 follow a first-shade-to-second-shade gradient based on timestep progression, with the second shade corresponding to later timesteps that often coincide with failure (e.g., where the first shade is darker than the second shade). Plot 102 visualizes the same set of t-SNE features, colored based on task ID. FIG. 1 also includes examples 112, 114 of rollouts over time, with their corresponding projected features marked in plots 100 and 102.

Plot 100 of FIG. 1 demonstrates that when the VLA is failing, its internal features are grouped in the same region in the feature space (failure zone 104). Between plots 100 and 102 of FIG. 1, it is noted that even when the features are extracted from different tasks with various instructions, objects, and/or environments, when the VLA fails, its features fall in the same failure zone 104, 106. Examples 112, 114 further illustrate how the VLA's features evolve in the feature space when the VLA progresses temporally. From examples 112, 114, it is noted that failure rollout initially stays out of the failure zone when the VLA progresses normally, and when the robot mistakenly drops the pot in the middle of execution in the example depicted in FIG. 1 and starts to fail, the VLA steps into the failure zone. On the contrary, for the successful rollout, its features always stay out of the failure zone.

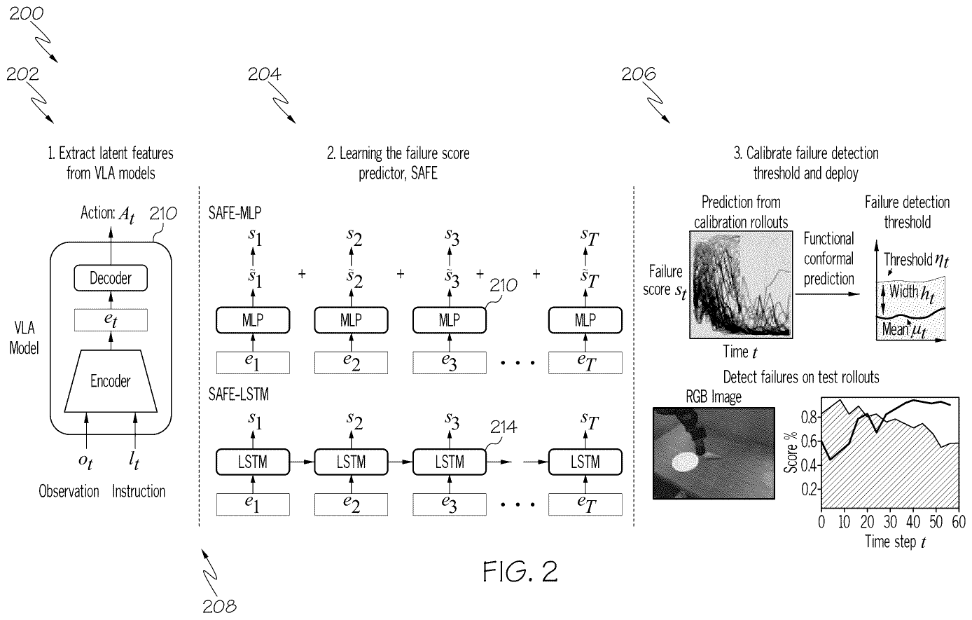

This visual analysis shows that the VLA's internal features for succeeding and failing task executions are well separated in the feature space, and this separation is general across different tasks. Furthermore, during task execution, the features reflect how well the VLA performs on the current tasks in a timely manner. Based on this observation, the scalable adaptive failure estimation model of the present disclosure uses the internal features of VLAs for failure detection. An overview of the method for the scalable adaptive failure estimation model is shown in FIG. 2.

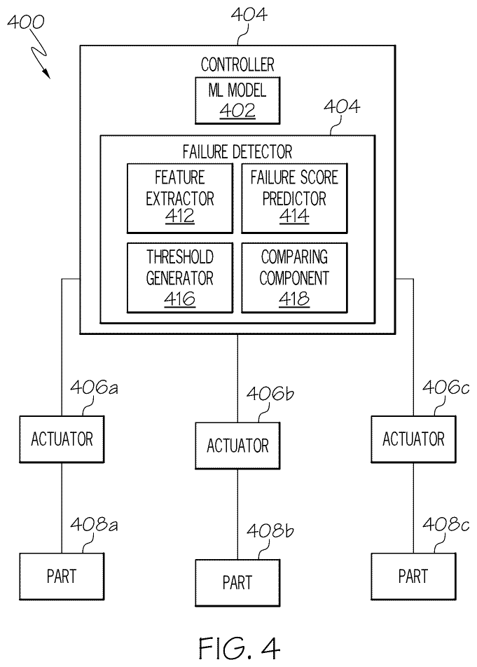

FIG. 2 illustrates steps or components of a failure detector 208 (implementing the scalable adaptive failure estimation model described herein). The failure detector 208 (e.g., a scalable failure estimation system, also referred to herein as “SAFE”) includes three components or steps: (1) in step 202, the failure detector extracts the latent feature from the last layer of a VLA model 210 (e.g., performed by feature extractor 412 of FIG. 4); (2) in step 204, the failure detector (e.g., sequentially) processes the latent feature and predicts a failure score (e.g., using a multi-layer perceptron (MLP) 212 or a long short-term memory (LSTM) 214, such as performed by failure score predictor 414 of FIG. 4); and (3) in step 206, the failure detector determines a time-varying threshold using functional conformal prediction (CP) on a hold-out calibration set (e.g., performed by threshold generator 416 of FIG. 4). Based on the predicted failure score exceeding the threshold during testing (e.g., as compared by comparing component 418 of FIG. 4), the failure detector 208 (e.g., including the VLA model 210 and the MLP 212 and/or the LSTM 214) detects a failure.

In certain embodiments, the scalable adaptive failure estimation model may learn the abstract information from the VLA's internal features and determine whether the task execution is failing. The VLA's hidden state vectors may be extracted from the final layer, before being decoded to token logits or a velocity field. Different ways were ablated to aggregate the internal features into a single embedding vector e, and select the best one based on Dₑᵥₐₗ₋ₛₑₑₙ performance. Details on VLA feature extraction are described further, below.

The failure detector f(e_{0:t}) takes as input the VLA's features e_{0:t}={e₁, . . . , eₜ} up to the current timestep t, and is trained to predict sₜ. The two backbone designs for the failure detector (a multi-layer perceptron (f_{MLP}) and an LSTM (f_{LSTM})) are described herein. Both models are designed to include one or two layers, to avoid overfitting and improve generalization ability on unseen tasks. For f_{MLP}, an MLP g(·) may be used to project er into a single scalar for each timestep t independently and accumulate the outputs as the failure score. That is, f_{MLP} (e_{0:t})=Σ_{τ=, . . . ,t}σ(g(eτ), where σ(·) is a sigmoid function and therefore 0<sₜ<t. To train the MLP model, an L1 loss may be applied on all timesteps to push up the scores for failed rollouts and push down those for successful ones. Specifically, L_{MLP}=

$${{\sum }_{i}}_{{D}_{train}} [ {y}_{i} {\sum }_{t} ( t - {s}_{t} ) + ( 1 - {y}_{i} ) {\sum }_{t} {s}_{t} ] ,$$

where index i iterates over all data points in

For f_{LSTM}, an LSTM model may be used to sequentially process the input stream of VLA's features e_{0;t} and project the hidden state vector of LSTM into a scalar score. Specifically, f_{LSTM}(e_{0:t})=σ(LSTM(e_{0:t})), where a sigmoid function σ(·) is applied to normalize the output score s.t. 0≤sₜ≤1. To train the LSTM model, a binary cross entropy loss may be applied on all timesteps. That is,

$${L}_{LSTM} = {\sum }_{i} {\sum }_{t} [ {y}_{i} log ( {s}_{t} ) + ( 1 - {y}_{i} ) log ( 1 - {s}_{t} ) ] .$$

When the predicted failure score sₜ exceeds the time-varying threshold δₜ, a failure flag may be raised. To determine δₜ, the functional conformal prediction (CP) framework may be adopted. Functional CP constructs a time-varying prediction band by leveraging the distribution of sₜ observed in successful rollouts within a calibration set. Under the exchangeability assumption and given a user-specified significance level α, the CP band may guarantee that, for a new successful rollout, its sₜ will lie within this band at all times t with probability 1-α. Conversely, if the score of a test rollout exceeds the band at time t, a failure may be declared with nominal confidence 1−α.

Given a time series of any scalar score sₜ and a user-specified significance level a ∈ (0, 1), functional CP gives a distribution-free prediction band C_{α}. In some cases, a one-sided time-varying CP band formulation may be adopted, where C_{α} is a set of intervals {[lowerₜ, upperₜ]:t=1, . . . , T}, where lowerₜ=−∞ and upperₜ=μₜ+hₜ, with a time-varying mean μₜ and a bandwidth hₜ. This band is calibrated on successful rollouts in Dₑᵥₐₗ₋ₛₑₑₙ. Under certain mild assumptions, for any new successful rollout, sₜ<μₜ+hₜ holds for all t=1, . . . , T with probability 1−α. Intuitively, this allows the false positive rate of the failure detector (e.g., when a failure flag is raised at any time during a successful rollout) is at most α. upperₜ may be used as the failure flag threshold δₜ, and more details about functional CP are provided, below.

### Experiments

With respect to experiments with the scalable adaptive failure estimation model described herein, the LIBERO benchmark has been widely adopted for evaluating VLA models in simulation. Among the LIBERO task suites, the LIBERO-10 suite consists of 10 long-horizon tasks with diverse objects, layouts, and instructions, and may be considered the most challenging one. LIBERO-10 was used in the experiments, and testing for OpenVLA, π₀, and π₀-FAST was performed on it. The experiments were conducted by adopting the model checkpoints that were finetuned on the LIBERO benchmark. For the experiments, 3 out of 10 tasks were randomly picked and reserved as unseen tasks.

SimplerEnv provides a high-fidelity simulation environment for manipulation policies, which are replicas of the demonstration data from RT-series and BridgeData V2. On SimplerEnv, testing was performed for pretrained π₀ models from a reproduction, which are denoted as

$${π}_{0}^{*}$$

herein. The failure detection methods were trained and evaluated on the Google Robot embodiment and on the WidowX embodiment, respectively. The “pick up coke” task was excluded because

$${π}_{0}^{*}$$

rarely fails on it (sucess rate at 98%). This leaves 4 tasks for each embodiment, among which 3 tasks are seen and 1 task is unseen.

For real-world Franka Experiments, a π₀-FAST-DROID checkpoint was deployed on a Franka Emika Panda Robot. This checkpoint was finetuned on the DROID dataset. Demonstrations were not further collected, and the VLA model was not further finetuned. 13 tasks were designed, and 30 successful and 30 failed rollouts were collected for each task. In experiments, 3 tasks out of 13 were randomly selected as unseen tasks.

For real-world WidowX Experiments, the OpenVLA model was deployed, where the model was pretrained on the “Open-X Magic Soup++” dataset on a WidowX robot manipulator. With this setup, a total of 532 rollouts were collected on the 8 lifting and pick-and-place tasks, including 244 successful and 288 failed rollouts. In this experiment, 2 tasks out of 8 were randomly selected as unseen tasks.

Estimating uncertainty in generated responses has been used to detect truthfulness or hallucination in LLMs. For VLAs, uncertainty in the generated actions may indicate a lack of ability to solve the given task, and thus correlates with task failures. Therefore, the UQ methods were first adapted to VLAs and used as failure detection baselines.

Token uncertainty-based methods aggregate the predictive uncertainty from each generated token. These methods are efficient, as they only require a single forward inference. Given the generated tokens

$${W}_{t} = [ {w}_{t}^{1} , … , {w}_{t}^{m} ] ,$$

where the probability of sampling the token

$${w}_{t}^{i}$$

is denoted as pᵢ and the entropy over the distribution of the i^{th} token as Hᵢ. The token-based uncertainty estimation methods were adopted as follows:
Token max prob.:maxᵢ(−log pᵢ);

$$Token avg prob \text{. :} - \frac{1}{m} {\sum }_{i} log {p}_{i} ;$$

Token max entropy: maxᵢHᵢ;

$$Token avg entropy : \frac{1}{m} {\sum }_{i} {H}_{i} .$$

Sample consistency-based methods estimate uncertainty as the inconsistency within multiple generated sentences. For VLA models, the output actions are continuous vectors, and inconsistency may be measured by their variance. Specifically, at time t, given K sampled actions

$${A}_{t} = {\{ {A}_{t}^{k} \}}_{k = 1 , … , K} ,$$

the uncertainty may be measured as the total variation over the set of vectors: action total var.=trace(cov(Aₜ)). Similarly, variation for the translational (trans. total var.), rotational (rot. total var.), and gripper control (gripper total var.) components of Aₜ may be computed.

Furthermore, cluster entropy may be defined as entropy (cluster

$$( {\{ {A}_{t}^{k} \}}_{k = 1 , … , K} ) ) ,$$

where cluster(·) generates an integer set, containing k cluster labels for the k actions and entropy(·) measures the entropy of the integer set. UQ methods based on sample consistency may perform better for LLM, but they necessitate multiple inferences, which may not be practical for large VLAs that control robots in real time.

With respect to embedding distance, baselines that directly use the distances in the feature space may be compared as failure scores. Specifically, instead of training a neural network, all VLA embeddings from Dₜᵣₐᵢₙ may be stored in the two feature sets, E_{succ} and E_{fail}, containing all VLA embeddings from successful and failed rollouts, respectively. During evaluation on Dₑᵥₐₗ₋ₛₑₑₙ and Dₑᵥₐₗ₋ᵤₙₛₑₑₙ, failure scores are computed as sₜ=d(eₜ, E_{succ})−d(eₜ, E_{fail}), where d(·,·) measures the distance between a single vector and a set of vectors. Intuitively, if er is far from E_{succ} and close to E_{fail}, it is more likely to fail. In some cases, different types of distance were ablated, including Mahalanobis distance, and Euclidean and Cosine distance averaged over k-Nearest Neighbors of eₜ. In some cases, comparison was made to the PCA-KMeans distance measure.

With respect to learned OOD detector, LogpZO and RND were adopted for OOD detection-based failure detectors. Both methods use a neural network f^{OOD}(·) to model the embedding distribution from successful rollouts and return an OOD score for a new embedding. They were adapted to learn from both successful and failed rollouts by training two models,

$${f}_{succ}^{OOD} ( \cdot ) and {f}_{fail}^{OOD} ( \cdot ) ,$$

on E_{succ} and E_{fail}, respectively. Similar to embedding distance baselines, the failure score may be computed as

$${s}_{t} = {f}_{succ}^{OOD} ( {e}_{t} ) - {f}_{fail}^{OOD} ( {e}_{t} ) .$$

With respect to action consistency, STAC detects policy failures by measuring the statistical distance on the overlapping segment of two consecutive predicted action chunks. As it requires sampling multiple actions from the policy, it compromises real-time operation for real robots, because unlike relatively small diffusion policy networks, large VLAs are not optimized for parallel inference. Therefore, STAC was only tested in the simulation experiments with 10 sampled actions. STAC-Single, a real-time version of STAC, which computes action inconsistency using only one sample from each inference timestep, was also adopted. Since OpenVLA only outputs one-step immediate action (H=1), STAC and STAC-single do not apply to it.

Two types of evaluation were considered. The first type evaluates how well sₜ separates the successful and failed rollouts across all possible selections of δₜ. Following the evaluation protocol typically adopted for the LLM UQ, the area under the ROC curve (ROC-AUC) metric was used. Furthermore, because a failure flag is raised whenever sₜ exceeds δₜ, a successful rollout (e.g., ground truth negative) becomes a false positive whenever sₜ>δₜ, and remains a true negative only if sₜ≤δₜ for all time. Thus, the max-so-far score s̅ₜ=max_{r=1, . . . , t} sₜ is used, and the ROC-AUC metric is computed based on s̅_{T}, the maximum failure score throughout the entire rollout.

The second type of evaluation utilizes δₜ=upperₜ calibrated by functional CP. By setting the significance level α, a decisive positive/negative detection may be obtained for each rollout. The following metrics were also considered: true positive rate (TPR), false positive rate (FPR), balanced accuracy (bal-acc), and averaged detection time (T-det), where bal-Acc=(TPR+TNR)/2. T-det is the relative timestep where sₜ>δₜ for the first time (if sₜ never exceeds δₜ, T-det becomes 1), averaged over all ground truth failed rollouts.

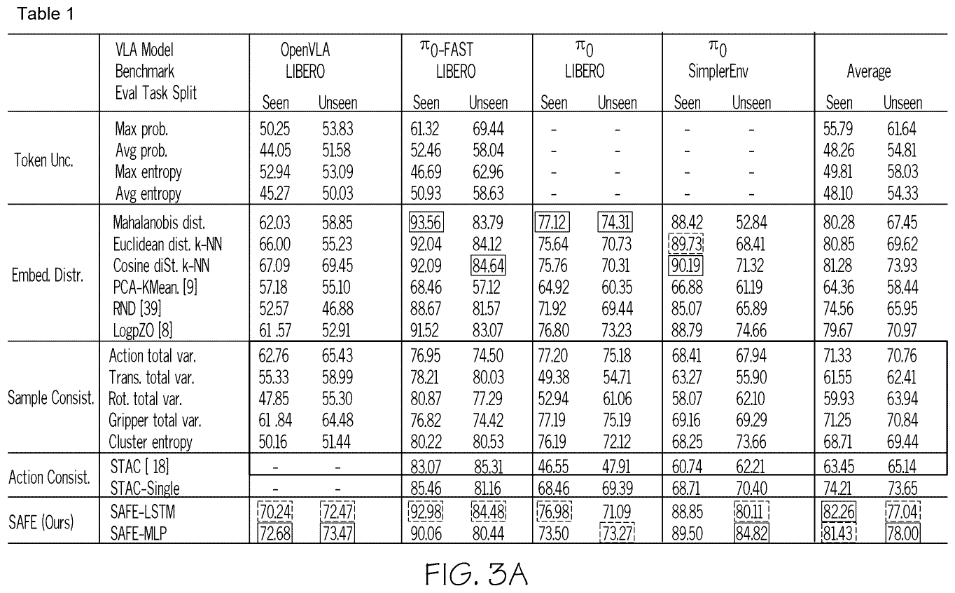

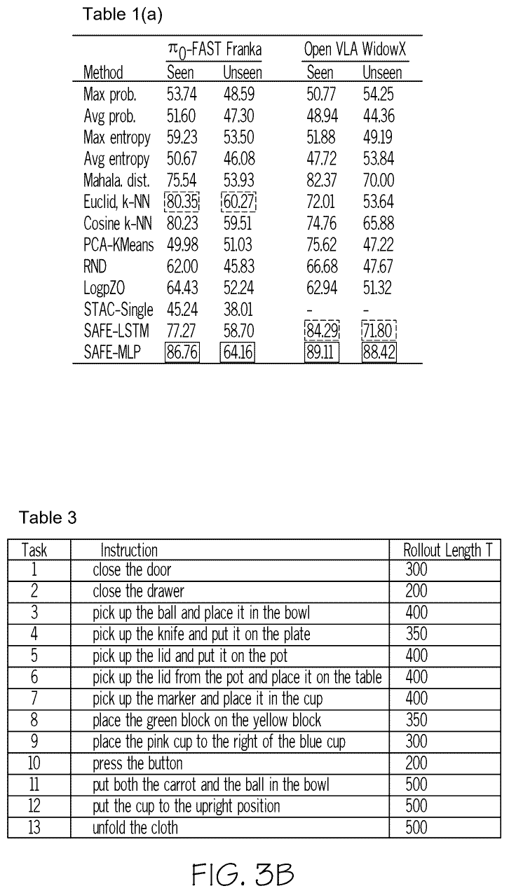

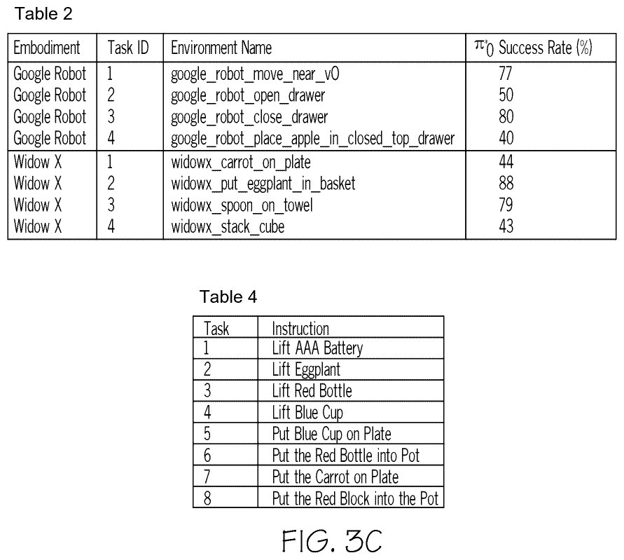

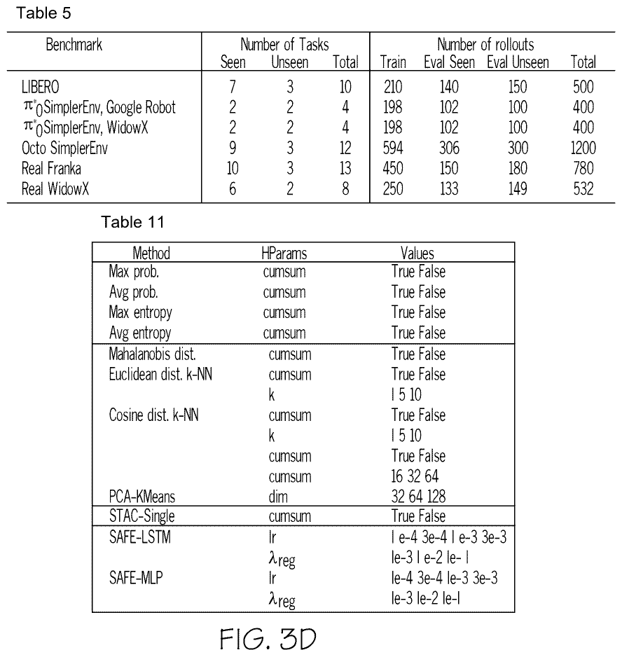

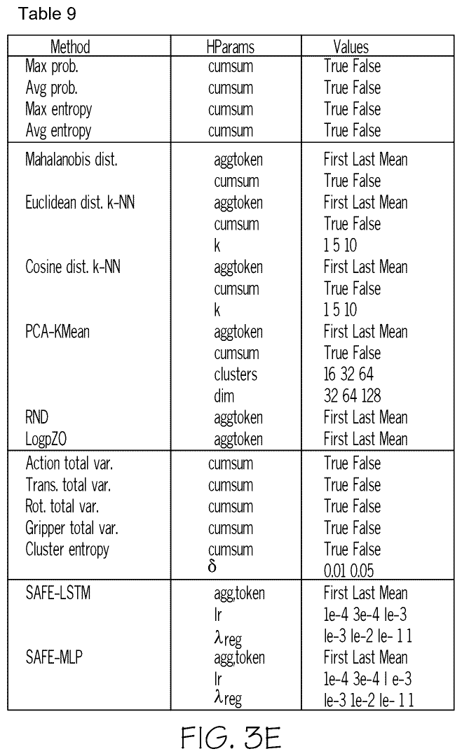

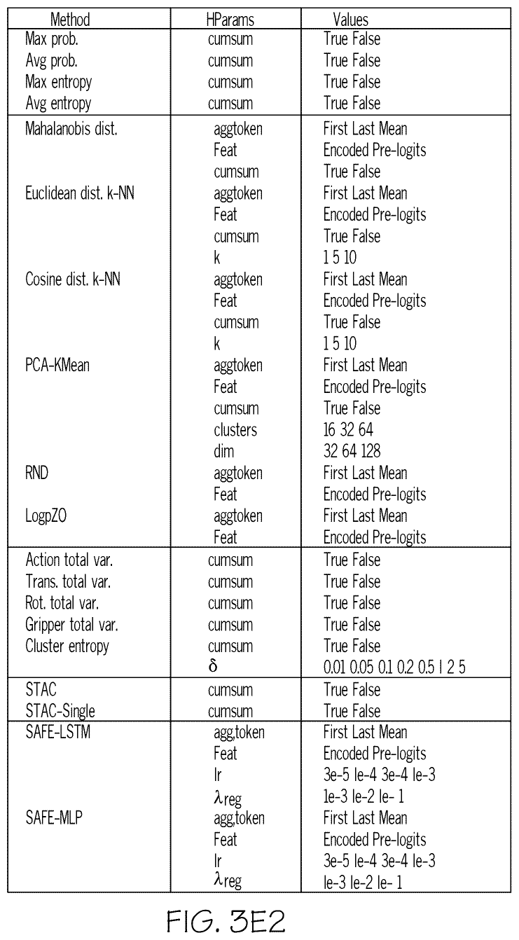

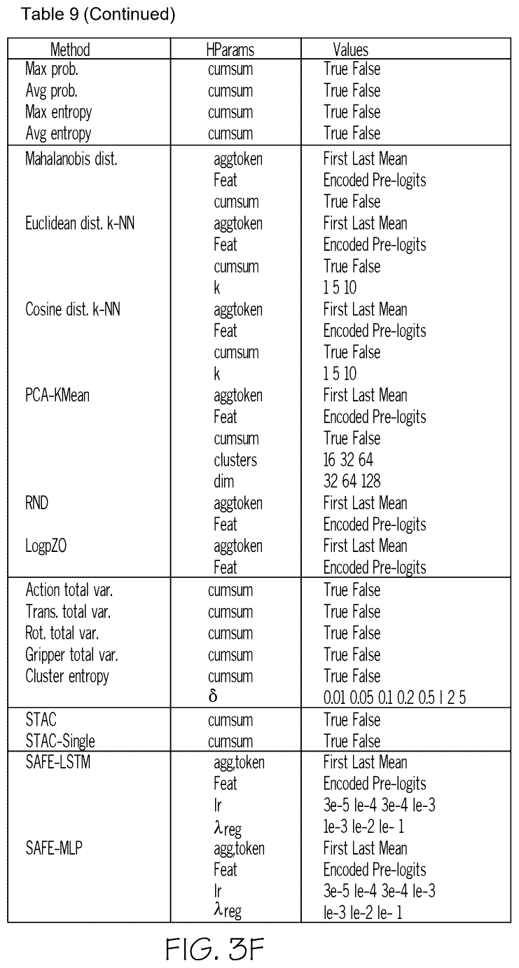

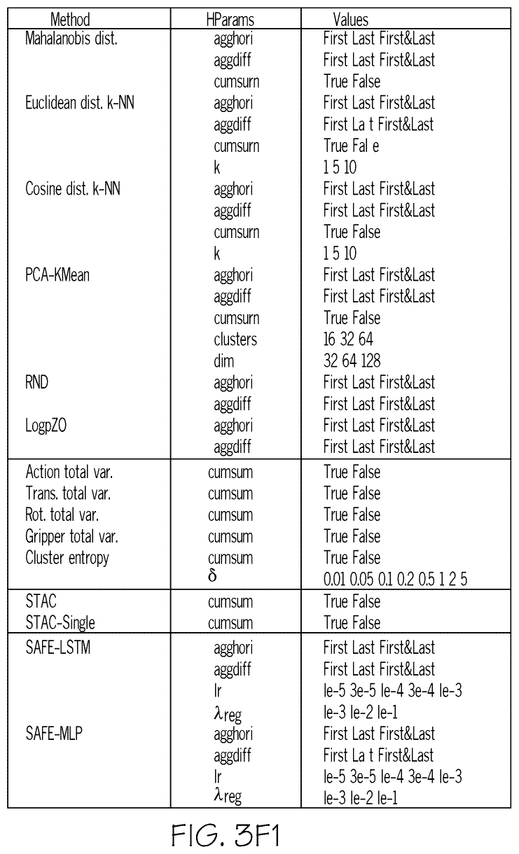

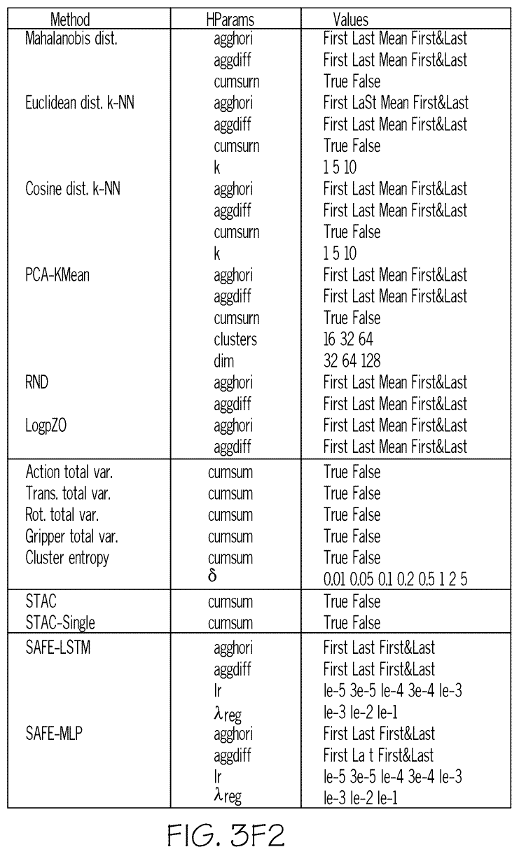

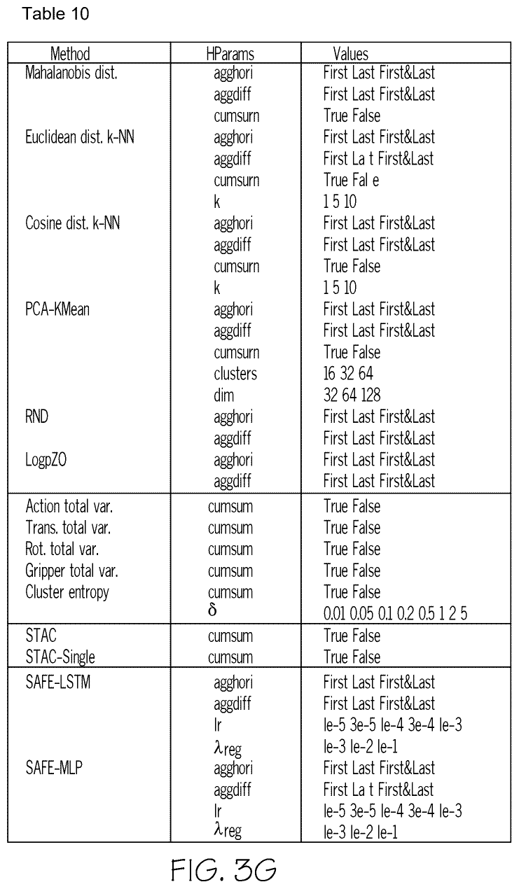

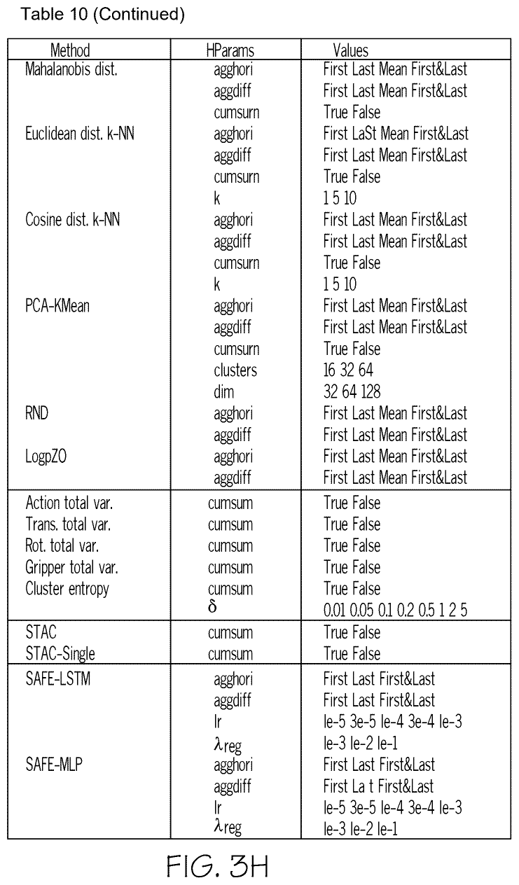

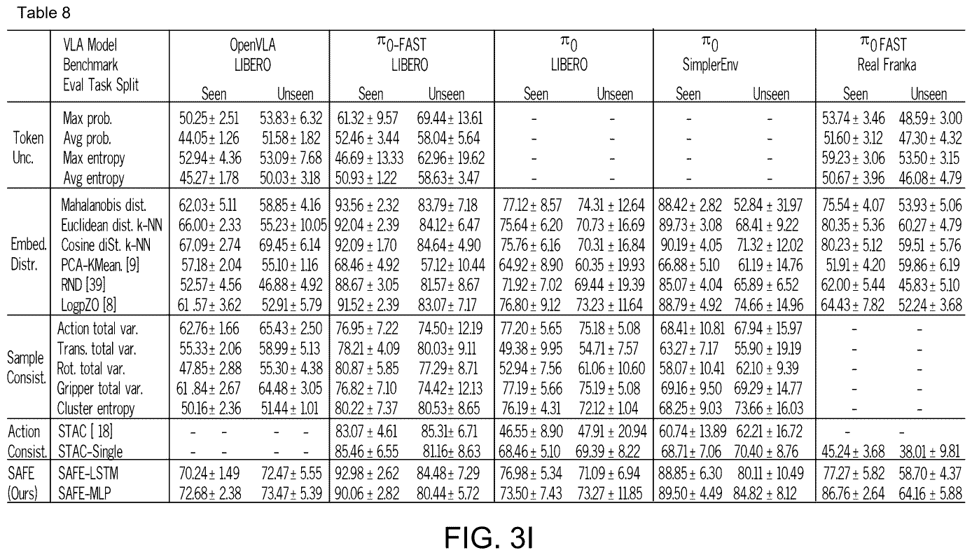

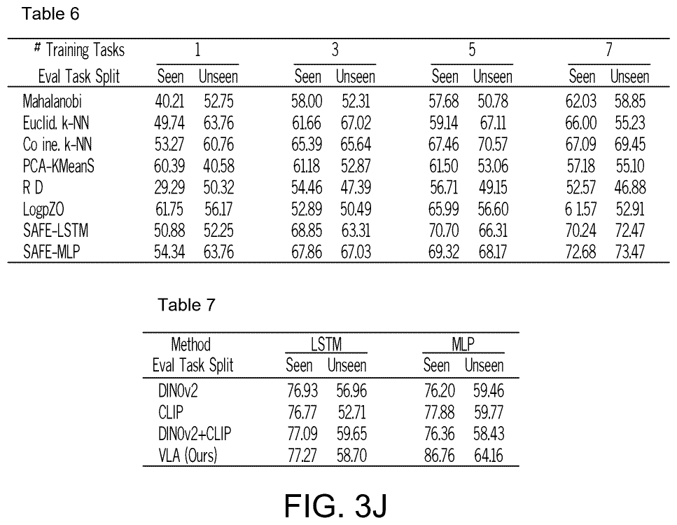

In Table 1 shown in FIG. 3A and Table 1 (a) shown in FIG. 3B, the ROC-AUC metric based on s̅_{T} is reported, for simulation and real-world experiments, respectively. With a higher ROC-AUC metric, a failure detector achieves higher accuracy averaged over all possible thresholds. The tables show that Token Unc, methods have poor performance. On the other hand, the Sample Consist, and STAC methods, which require multiple action samples, perform better and even achieve the best performance on unseen tasks in π₀-FAST LIBERO (STAC) and π₀ LIBERO (Gripper total var.). However, as these methods require multiple action samples, they cause significant overhead for VLA models and thus are not practical for real robots. Embed. Distr, methods perform well, achieving the best performance in two simulation benchmarks (π₀ and π₀-FAST) and are the second best in the real world experiments. This demonstrates that a VLA's internal features are informative about task execution success/failure. The scalable adaptive failure estimation model methods perform better or on par with certain baselines, consistently in all settings. Averaged across simulation benchmarks, SAFE-MLP and SAFE-LSTM have similar performance, both outperforming the best baseline by 4-5% on unseen tasks, while still achieving the best performance on seen tasks. For the real-robot experiments, on both π₀-FAST+Franka and OpenVLA+WidowX rollouts, SAFE-MLP achieves the best performance and SAFE-LSTM performs closely with the best baseline (Mahala. dist, and Euclid. k-NN). Comparing SAFE with Embed. Distr, methods, the success of SAFE may be attributed to its stronger ability to extract high-level abstract information from raw feature vectors through learned neural networks.

In some cases, Dₑᵥₐₗ₋ₛₑₑₙ was used to calibrate the functional CP band C_{α}, and evaluation was performed on Dₑᵥₐₗ₋ᵤₙₛₑₑₙ. By varying the user-specified α, the conservativeness of the failure detectors may be adjusted for obtaining a trade-off between accuracy (bal-acc) and detection time (T-det). A good failure detector may detect failures both accurately (higher bal-acc) and promptly (lower T-det). The SAFE-MLP and SAFE-LSTM setups performed the best on OpenVLA+LIBERO and π₀+SimplerEnv benchmarks, and were on par with the best baseline on the other two benchmarks. The ground truth (GT) failure timesteps (when a human thinks that failure happens or intervention is needed) were manually annotated for failed rollouts. Comparing SAFE's performance with the GT fail time, it was noted that SAFE can detect failures with high accuracy in the early stages of rollouts and potentially before the failure happens. This early detection allows early intervention for policy failures before they get stuck in execution or cause harm to the real-world environment.

In some cases, rollouts with the failure scores detected by SAFE were investigated. Common failure modes in simulation included imprecise insertion, oscillatory motions, and missed grasps. In certain two successful rollouts on the real robot, failure scores stopped increasing after task completion. For the failed rollouts, the failure flag was raised after the policy was frozen or the object slipped out of the gripper.

SAFE (failure detector) described herein uses a 1-2 layer MLP or LSTM and poses a minimal (e.g., less than 1%) computational overhead at runtime. For example, SAFE-LSTM contained 2.3 million parameters and introduced an additional 0.73 ms of inference time. This is negligible compared to overhead associated with large VLA models. For instance, pi0 has 3.3 billion parameters and an inference time of 149 ms. SAFE requires only access to the latent features of VLA models and is compatible with any white-box robot policies based on neural networks. However, SAFE does require deploying the policy and collecting successful and failed rollouts to train the failure detector before it can detect failures.

Experiments were conducted on 3 existing large VLA models: OpenVLA, π₀, and π₀-FAST. Given the internal feature vectors E ∈ R^{n×d′} produced by a VLA model, where dimension n corresponds to different token positions, diffusion steps, etc. and d is the feature dimension, E was aggregated into a single fixed-dimensional feature vector e ∈ R^{d} before inputting to the SAFE models. The following ways of feature aggregation were considered and ablated: (1) take the first vector along the dimension n, e=E₁; (2) take the last vector along the dimension n, e=Eₙ; (3) take average over the dimension n,

$$e = \frac{1}{n} {\sum }_{i = 1}^{n} {E}_{i} ;$$

and (4) concatenate the first and the last vector, e=concat(E₀, Eₙ) ∈ R^{2d′}.

Both OpenVLA and π₀-FAST first predicted a sequence of discrete tokens and then converted them into continuous actions. Feature vectors were taken before being decoded into the output tokens from the last transformer block as E ∈ R^{n×d′}, where n corresponds to the number of generated tokens. The aggregation method was ablated along this dimension and denoted as aggₜₒₖₑₙ. For π₀-FAST, additional ablation was performed using the feature vectors before (“encoded”) and after (“pre-logits”) the final RMS normalization layer as E.

Differently, π₀ (and π₀) output action vectors by flow matching, and the feature vectors were taken before being projected into the velocity field. With π₀ predicting an action chunk of horizon H and performing k flow matching steps being supposed, the internal features become E ∈ R^{H×k×d}, and the aggregation process was performed along the H dimension and the k dimension separately to get the final embedding vector e ∈ R^{d′}. The aggregation methods were denoted as aggₕₒᵣᵢ and agg_{diff} along these two dimensions, respectively.

For all VLA models, different methods of aggregating the hidden features E into a single feature vector e were ablated, and the best method was selected according to Dₑᵥₐₗ₋ₛₑₑₙ performance.

SAFE-LSTM used an LSTM model with 1 layer and a hidden dimension of 256, and an additional linear layer was used to project the hidden states of LSTM into a single scalar sₜ. SAFE-MLP used a multi-layer perceptron with 2 layers and a hidden dimension of 256. Since successes and failures from the generated rollouts were imbalanced, the losses on positive (failed) and negative (successful) rollouts were weighted by their inverse class frequency. An L2 regularization loss was also applied on the model weights to reduce overfitting, and this loss was weighted by λ_{reg} and optimized together with the failure score learning loss L_{LSTM} or L_{MLP}. λ_{reg} were determined by grid search.

For the cluster entropy baseline, agglomerative clustering was used with the ward linkage criterion. The distance threshold was denoted as δ and decided by grid search.

For the STAC baseline, the Maximum Mean Discrepancy (MMD) distance measure was used with radial basis function kernels. The bandwidth of the RBF kernel was 1.

For all baselines except for RND and LogpZO, one version that only considers the failure score computed from the current timestep (“cumsum=False”) was ablated, and another that uses the cumulative sum (cumsum) of the failure scores over time (“cumsum=True”).

For RND and LogpZO, the original implementation was used, and scores were not accumulated. In some cases, RND and LogpZO were trained to model the distribution of (encoded) observations or and predicted actions Aₜ. They were adapted to model the distribution of VLA's internal embeddings eₜ.

As π₀

$$( and {π}_{0}^{*} )$$

) does not output discrete tokens, token uncertainty-based baselines did not apply. For OpenVLA, H=H′=1, and thus the STAC and STAC-Single did not apply.

In the experiments, the adaptive modulation function was used, which models the non-extreme behaviors of the functional data.

The LIBERO-10 task suite was adopted, which contains the most diverse set of objects, environments, and instructions among the 4 LIBERO task suites, where LIBERO-10 is considered the most challenging task suite. LIBERO-10 contains 10 tasks with 50 rollouts in each task. The initial conditions for all rollouts were used as specified and provided for certain existing methods. To test VLA models on LIBERO, the trained model weights provided by certain existing methods were used without further finetuning. On LIBERO-10, OpenVLA achieved a success rate of 53.7%, π₀-FAST achieved 60.2%, and π₀ achieved 85.2%. For evaluation, 3 out of 10 tasks were unseen, and within seen tasks, 60% of rollouts were used for Dₜᵣₐᵢₙ and the remaining 40% for Dₑᵥₐₗ₋ₛₑₑₙ.

The LIBERO simulator stops the rollout execution when the robot finishes the task (considered a success) or a maximum rollout length is reached (considered a failure). Therefore, in the generated rollouts, failed ones always have the maximum length, but successful ones are shorter. This could result in an unfair advantage for some of the compared failure detectors (if a failure detector simply learns to count the time elapsed, i.e., sₜ=t, it will achieve perfect failure detection since failed rollouts have a fixed and longer duration). To ensure a fair comparison, for evaluation in Table 1 shown in FIG. 3A, the minimum rollout length was computed for each task and used as T for that task. The failure detection performance (in ROC-AUC) was then determined based on s_{T}, where T is the same for all successful and failed rollouts within each task.

SimplerEnv identifies and reduces the domain gap between the simulation and the real-world demonstration data, and provides simulated environments that highly resemble the demonstration data from RT-series (with the Google Robot embodiment) and BridgeData V2 (with the WidowX embodiment). They show that models pretrained on real-world datasets can also accomplish similar tasks in SimplerEnv without finetuning, and their performance in simulation matches that in the real world.

On this benchmark, the pretrained model checkpoints of

$${π}_{0}^{*}$$

were adopted. Note that

$${π}_{0}^{*}$$

model checkpoints are trained separately on the Google Robot embodiment and the WidowX embodiment, which results in two model checkpoints that have different internal feature spaces. Therefore, all failure detectors are trained and evaluated on each embodiment separately as well. All reported evaluation metrics were computed separately for each embodiment and then averaged. In Table 2 shown in FIG. 3C, the tasks used for failure detection on SimplerEnv are listed. 100 rollouts were generated for each task with random initial configurations, and the success rates of

$${π}_{0}^{*}$$

on each task are also listed in Table 2 shown in FIG. 3C. A rollout was stopped after the maximum number of allowed timesteps have passed, regardless of task success or failure. Within each embodiment, 1 out of 4 tasks was unseen, and within the seen tasks, 66% of the rollouts were in Dₜᵣₐᵢₙ and the remaining 33% in Dₑᵥₐₗ₋ₛₑₑₙ.

Regarding real-world experiments with Franka robot, in Table 3 shown in FIG. 3B, the tasks used in the real-world experiments are listed. For each task, a number of timesteps T allowed for one rollout was set, and all rollouts of the same task were terminated after the same T timesteps regardless of task success or failure.

Regarding real-world experiments with WidowX robot, the OpenVLA model pretrained on the “Open-X Magic Soup++” dataset was tested on a real WidowX robot arm. In this experiment, a total of 532 rollouts were collected on 8 tasks (listed in Table 4 shown in FIG. 3C), with 244 successes and 288 failures. Each task had roughly the same number of rollouts.

In the Table 5 shown in FIG. 3D, the statistics on the number of tasks and rollouts collected for each benchmark are summarized, as well as how they are split into training and evaluation subsets. As SAFE is designed for multitask failure detection, it is trained on only a limited set of training tasks and rollouts and can generalize to new tasks without further collecting rollouts. While SAFE does require hundreds of rollouts from multiple tasks during training, when handling new tasks, SAFE becomes more efficient than existing task-specific failure detectors that require collecting rollouts for training and calibration for every new task encountered.

In some cases, Adam optimizer was used with β₁=0.9, β₁=0.999, €=10⁻⁸, and a learning rate (lr) determined by grid search. The SAFE models were trained for 1,000 epochs with batch size 512. Each rollout was considered as one data point, and thus batch size of 512 translates to training on (at most) 512 rollouts in each iteration. All training and evaluation were done on a single NVIDIA A100 40 GB GPU. Since SAFE uses small networks (MLP or LSTM with 1 or 2 layers), the typical training time for one model is less than one minute.

To determine the hyperparameters for the SAFE and baselines, a grid search was performed over them for selecting the ones with the highest failure detection performance (ROC-AUC) on the Dₑᵥₐₗ₋ₛₑₑₙ split. In Table 9, Table 10, and Table 11 shown in FIGS. 3E-3F, 3G-3H, and 3D, the hyperparameters that were searched over and the values with the best performance are included. For the real-world experiments, the eₜ was fixed to be the “pre-logits” with “Mean” aggregation.

Feature analysis was performed on other benchmarks. In this feature analysis process, the t-SNE algorithm was performed on the VLA's embeddings without any learning. Therefore, the feature dimension reduction process was unsupervised and did not know about task successes or failures.

For the plots in FIG. 1 and from the feature analysis performed on other benchmarks as described above, it was noted that the embedding spaces from VLAs were different from each other, which corresponds to the different failure patterns presented by the VLAs. For π₀-FAST (FIG. 1) and π₀ on LIBERO, when task execution fails, the embeddings fall into the same region (“failure zone”). This corresponds to the major failure mode of π₀-FAST trained on the LIBERO dataset, where the predicted actions Aₜ become unstable and the robot arms move to weird configurations and out of the observation frame. For OpenVLA on LIBERO, it was observed that for most failed rollouts, the robot frozen at or shook around certain configurations during the middle of task execution. Such failed rollouts resulted in features very close to each other.

Despite the different appearances of the embedding spaces from the above benchmarks, their successful and failed rollouts were separable in the feature space. This is aligned with the high performance of the SAFE described herein and the embedding-based baseline methods. Moreover, although the embeddings of the failed rollouts from OpenVLA were spread over the space and did not form a unified “failure zone,” SAFE was still able to learn to separate task failures from successes and generalize well to unseen tasks, as reported in Table 1 shown in FIG. 3A.

However, the visualized embeddings of π₀-FAST on the real Franka robot were different, where embeddings from successful and failed rollouts were not easily separable through the t-SNE visualization. Because the tasks that were used for real-world experiments were more diverse, their failures may not have had a unified semantic meaning, and thus the embeddings may not have been clearly separated in the visualization. Certain limited performance of failure detection methods may be attributable to this, where ROC-AUC was at most 64 on Dₑᵥₐₗ₋ᵤₙₛₑₑₙ. Nevertheless, SAFE-MLP still outperformed all baselines on both seen and unseen splits in this evaluation.

Functional CP was used to determine the time-varying thresholds δₜ for failure detection. By varying the significance level a used in functional CP, the conservativeness of failure detection could be adjusted for getting different performance. It was observed that while the metrics do vary with the α, choosing α=0.15 (or in general, between 0.05 and 0.2) performed well across the board. α was chosen to be 0.15 for most qualitative results and analyses performed with respect to the present disclosure.

The CP bands were calibrated on successful rollouts (negative data points), and thus if the assumptions used in CP (sₜ are sampled i.i.d.) hold, the TNR rate is lower bounded by and close to 1−α. However, as the multitask failure detection problem requires detecting failures on tasks that are not in the training or the calibration sets, CP bands needed to be calibrated on Dₑᵥₐₗ₋ₛₑₑₙ and then evaluated on Dₑᵥₐₗ₋ᵤₙₛₑₑₙ. Therefore, the i.i.d. assumption may not hold.

On OpenVLA+LIBERO and

$${π}_{0}^{*} + SimplerEnv benchmarks ,$$

the TNR curves obtained by SAFE were close to a line for 1−α, while those on the other 3 benchmarks were lower than 1−α. A similar phenomenon was also observed for the baseline methods: none of the TNR curves obtained from the baselines consistently conform to the 1−α curve across all benchmarks. This may be attributable to the challenging nature of the multitask failure detection problem, where the failure scores for calibration and evaluation may not come from the same distribution. Nevertheless, the functional CP was adopted as a principled method to determine the time-varying failure detection threshold δₜ. Moreover, it was noted that SAFE can achieve higher TPR and result in fewer false negatives compared to the baselines. This is crucial for safety-critical environments, where a missing failure (false negative) can be much more catastrophic than a false alarm (false positive).

When the failure happened for the failed rollouts, manual labeling was performed. The labeling process was based on video recordings after all rollouts were collected and no interventions were done during the task execution. While the exact times of failure are clear for some failure modes (e.g. dangerous actions, breaking objects), they can be ambiguous and hard to annotate for other failure modes. For example, a policy may freeze in the middle of task execution, and after that either recovering from it or getting stuck indefinitely can be possible. In another case, a policy may repeatedly try grasping the object but keep missing the grasp until timeout, and it may be hard to determine a single point of failure. To handle such cases, the human annotators were instructed to pick the time where they think intervention was needed and they should take over control to prevent an execution failure. In practice, for the above ambiguous failure modes, the failures are annotated after the policy gets stuck by a few seconds or re-tries the grasping action a few times. For some rollouts that look very plausible but do not succeed due to the time limit, the failure time is annotated as the end of the rollout. It is noted that only the failed rollouts were annotated and not the successful ones, even though they may also show subtle signs of failure in the middle.

The times of failure detected by the SAFE-MLP model and a human annotator were compared. For both π₀ and π₀-FAST models, SAFE-MLP could detect failures before they happened (as identified by a human). When used for π₀-FAST deployed on LIBERO, SAFE-MLP could forecast failures well in advance and even predict 40% of the failures after the first timestep.

Furthermore, it was noted in some cases, the human annotator did not think certain rollouts were failures until the very last moment, where the VLA model may have been on the right track and failed only due to timeout. Such failures may be hard for failure detectors to detect, and may explain the low performance of all failure detectors on these benchmarks.

In Table 8 shown in FIG. 3I, the standard deviation for all results in Table 1 and Table 1(a) shown in FIGS. 3A and 3B is shown. It is noted that for the repeated runs, not only are they using different random seeds, but also the tasks were split differently into the seen and the unseen subsets. Since different tasks have different difficulties for failure detection, it is normal to see large standard deviations in Table 8. From Table 8, it is noted that the SAFE methods described herein achieved high averaged performance with relatively low standard deviations compared to the baselines, across all evaluation benchmarks. This signifies the strong and stable performance of SAFE.

As SAFE learns to distinguish failures from successes from training rollouts, the diversity of failure modes and the number of tasks in the training data may have an effect on the failure detection performance. To quantify this effect, an experiment was conducted, where the number of seen tasks that are used in training was varied. It was noted that different tasks typically also have different failure modes, and in this way, the diversity of failure modes was also ablated.

In Table 6 shown in FIG. 3J, the failure detection for ROC-AUC on the OpenVLA+LIBERO benchmark, trained on different numbers of tasks, is shown. While the number of seen tasks was ablated, all experiments used the same set of unseen tasks for evaluation, and performance on unseen tasks was comparable. All numbers were averaged over 3 random seeds. Training-free methods did not depend on training tasks and are not shown.

Table 6 shown in FIG. 3J shows that for most methods, with more tasks used for training, the performance on unseen tasks gets better. The SAFE-MLP performed well in all settings and could also achieve good performance when fewer (3 or 5) tasks were used for training.

In Table 7 shown in FIG. 3J, SAFE-MLP and SAFE-LSTM was ablated using DINOv2 features, CLIP features, DINOv2 and CLIP concatenated (DINOv2+CLIP) features, and the VLA last-layer features. DINOv2 and CLIP features were extracted from the observation images, and this experiment was conducted over the real-world Franka rollouts. Numbers were averaged for ROC-AUC on the seen and unseen tasks.

The best performing method in the above table was the SAFE-MLP method based on VLA last-layer features, where VLA features outperformed other feature types by a large margin. This may be because VLA feature space learns high-level information about the tasks, and thus can more easily distinguish failures from successes than general pretrained models.

Failure detection, uncertainty quantification, and OOD detection are three closely connected concepts with subtle differences. SAFE learns to model the probability of failures and detect failures of VLA policies, but it achieves this not through uncertainty quantification (UQ) or OOD detection.

Failure detection is the task of detecting failures when a robot is performing certain tasks. SAFE learns the likelihood of failure through training on a set of successful and failed rollouts. SAFE-LSTM is trained by BCE loss and outputs a normalized score indicating the probability of failure of VLA. The output of SAFE-MLP is not normalized and thus not a probability. However, output scores from both SAFE-LSTM and SAFE-MLP are calibrated through functional conformal prediction and can be used for failure detection with theoretical guarantees.

Uncertainty quantification (UQ) measures a VLA's uncertainty in its outputs and can be used as a proxy for failure detection. In experiments described herein, the token uncertainty baselines and sample consistency baselines were inspired by LLM/VLM related methods and designed based on UQ. Methods in this category are typically training-free, but they only showed limited success.

OOD detection-based failure detection methods treat successful rollouts as normal execution conditions and assume that deviations from this norm lead to a higher chance of failure. In experiments that were performed, the embedding distribution-based baselines were designed to detect policy failure based on OOD detection. Methods in this category can work without failed rollouts. In experiments that were performed, they were adapted to take in both successes and failures, and they showed strong performance.

Uncertainty quantification methods have been used for LLM/VLM hallucination detection, and OOD detection-based methods have been shown to be effective for failure detection in robotics policies.

Different from existing works based on UQ or OOD detection, SAFE directly learns to detect failures from a history of observations and the language instruction specifying the desired task without using uncertainty or OOD detection as the proxy measurement. Experiments showed that this direct learning regime used by SAFE is more effective and achieves better performance than other methods.

FIG. 4 is a block diagram illustrating components of an example ML model system 400. As depicted, the system 400 includes a controller 404 including ML model 402 and failure detector 410, where ML model 402 may be an example of the VLA model 210 of FIG. 2 (e.g., a generalist VLA model), described herein with reference to FIG. 1 or 2, and failure detector 410 may be, or include, an example of the scalable failure estimation system, described herein with reference to FIG. 1 or 2. In certain examples, the controller 404 may be a controller for a robot system or a vehicle control system. Other examples of systems may also be possible consistent with the present disclosure.

The system 400 includes a plurality of actuators 406 (actuators 406a-c) coupled to the controller 404 and to a plurality of parts 408 (parts 408a-c), where the parts 408 may be parts for a robot system, a vehicle control system, or similar. Based on the prediction by ML model 402, the controller 404 may determine how the parts 408 may be actuated, respectively, by the actuators 406, such as to control a robot or a vehicle. For example, the controller 404 may generate and send (to an actuator) a control signal based on the prediction by ML model 402, such as to cause the part to be actuated according to the prediction.

As depicted, failure detector 410 includes feature extractor 412, failure score predictor 414, threshold generator 416, and comparing component 418. In some embodiments, the failure detector 410 may be or include a classifier of success or failure, where the classified data may include rollouts.

In certain embodiments, feature extractor 412 may be configured to extract (and may extract) features from one or more layers (e.g., the last layer) of a VLA model (e.g., VLA model 210 of FIG. 2). For example, the feature extractor 412 may read out (e.g., and obtain) the internal latent activations produced by the VLA model during its forward pass (e.g., typically from the final transformer block or last layer) before the VLA model converts those activations into action tokens or continuous action vectors.

In some embodiments, failure score predictor 414 may be configured to predict (and may predict) a failure score related to an action predicted by the VLA model (or to be performed or being performed by a robot), such as by processing the extracted features (e.g., using the MLP 212 or the LSTM 214 to sequentially process the extracted features, such as described with reference to FIG. 2). For example, the failure score predictor 414 may consume a time-ordered stream of embeddings {e₁, . . . , eₜ} and produce a scalar failure score sₜ for the current time (or replan step). Certain aspects may support a “per-step+accumulation” form (e.g., using the MLP 212) and/or an explicitly recurrent form (e.g., using the LSTM 214).

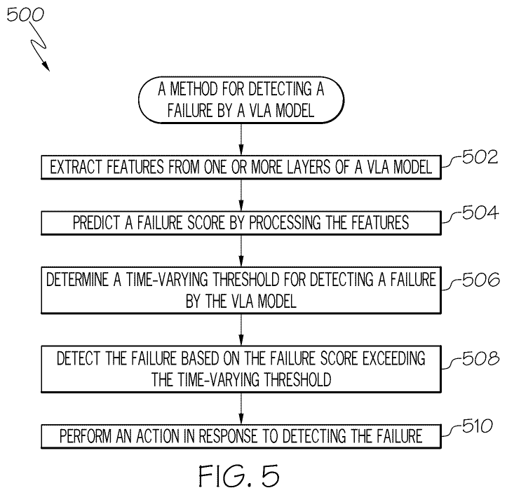

In certain embodiments, threshold generator 416 may be configured to generate (and may generate) a threshold related to detecting a failure by the VLA model or to the robot (e.g., the time-varying threshold described with reference to FIG. 2). In some embodiments, the time-varying threshold (δₜ) may be generated by functional conformal prediction (CP) on a hold-out calibration set, such as by (e.g., typically) using successful rollouts (e.g., such as described with respect to step 206 of FIG. 2 or block 506 of method 500 of FIG. 5). In some embodiments, based on a comparison of the predicted failure score against the generated threshold (e.g., based on the predicted failure score exceeding or satisfying the generated threshold, such as based on a comparison performed by the comparing component 418), the failure detector 410 may predict a failure by ML model 420 (e.g., in an action to be performed or being performed by the robot). Based on such prediction, the failure detector 410 may cause the controller 404 to interrupt or stop an action by the robot being controlled by the controller 404 (e.g., by generating an interrupt or stop signal, such as a control signal indicative of a request to stop an action, and sending the signal to an actuator).

In some cases, additionally or alternatively, the failure detector 410 may generate a flag related to the predicted failure, and generate and send an alert based on, or related to the flag, to a user (e.g., to a user interface accessible by the user, such as on a user device or through a user application), and/or perform other similar actions, such that the robot can stop, backtrack, or ask for help.

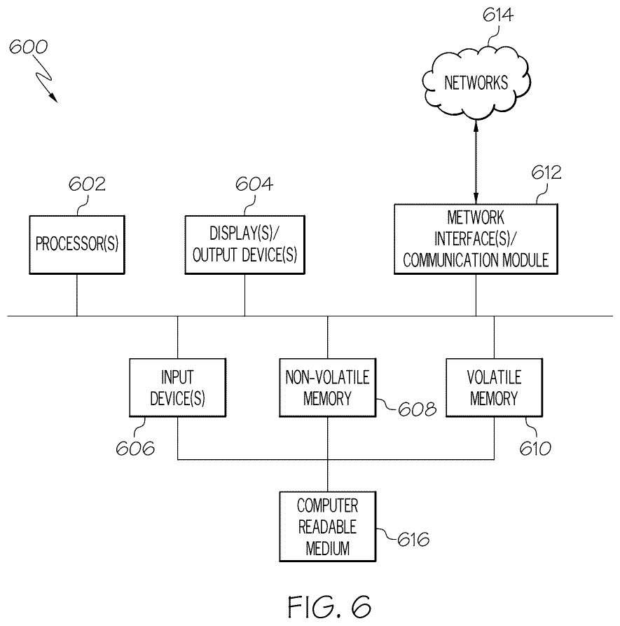

FIG. 5 is a flow chart depicting an example process, method 500. Method 500 may be performed for detecting a failure by a VLA model. In certain embodiments, method 500 can be implemented by the failure detector 208 of FIG. 2, the system 400 of FIG. 4, and/or computing device 600 of FIG. 6.

Method 500 begins, at block 502, with extracting features from one or more layers of a VLA model. In certain embodiments, extracting the features from the one or more layers of the VLA model at block 502 may be an example of extracting the features from a final (last) layer of VLA model 210, such as described with reference to FIG. 2.

Method 500 proceeds, at block 504, with predicting a failure score by processing the features. In certain embodiments, the predicting the failure score at block 504 may be an example of predicting the failure score by the failure score predictor 414 of FIG. 4, such as described with reference to FIG. 2 or 4.

Method 500 proceeds, at block 506, with determining a time-varying threshold for detecting a failure by the VLA model. In certain embodiments, determining the time-varying threshold at block 506 may be an example of determining a time-varying threshold by the threshold generator 416 of FIG. 4, such as described with reference to FIG. 2 or 4.

Method 500 proceeds, at block 508, with detecting the failure based on the failure score exceeding the time-varying threshold. In certain embodiments, detecting the failure at block 508 may be an example of detecting the failure by the failure detector 208 or the failure detector 410, such as described with reference to FIG. 2 or 4.

Method 500 proceeds, at block 510, with performing an action in response to detecting the failure. In certain embodiments, performing the action in response to detecting the failure at block 510 may be an example of performing an action by generating a control signal or transmitting an alert to a user interface or a user device, such as described with reference to FIG. 2 or 4.

In certain embodiments, extracting the features from the one or more layers of the VLA model comprises extracting the features from the last layer of the VLA model.

In some embodiments, predicting the failure score by processing the features comprises processing the features using a multi-layer perceptron (MLP).

In certain embodiments, predicting the failure score by processing the features comprises processing the features using a long short-term memory (LSTM).

In some embodiments, predicting the failure score by processing the features comprises processing the features sequentially.

In certain embodiments, determining the time-varying threshold comprises determining the time-varying threshold based on functional conformal prediction (CP) on a hold-out calibration dataset, the hold-out calibration dataset comprising data indicative of a successful action.

In some embodiments, performing the action in response to detecting the failure comprises: generating a control signal associated with one or more of stopping a predicted action or backtracking from the predicted action; and transmitting the control signal to a controller.

In certain embodiments, performing the action in response to detecting the failure comprises: generating an alert associated with the failure; and transmitting the alert to a user interface or a user device.

In some embodiments, detecting the failure comprises detecting the failure based on a plurality of rollouts executed based on a history of observations and a language instruction specifying a desired task.

In certain embodiments, the VLA model comprises a generalist VLA model, and the method further comprises inferring a predicted action, before the predicted action occurs, based on an input that is not included in a training dataset for a failure detector used for predicting the failure score, the input comprising one or more of a task not included in the training dataset or a visual input not included in the training dataset.

In some embodiments, method 500 provides a technical solution for the multitask failure detection problem for generalist VLA policies, where failure detectors are trained (e.g., only) on seen tasks and evaluated on unseen tasks. VLA's internal feature space is analyzed, where the internal features are separated for successful and failed rollouts. Based on this observation, method 500 provides for a simple and efficient failure detection method by operating on the VLA's internal features, with improved failure detection performance (e.g., for unseen tasks) when compared to existing methods of failure detection.

Turning to FIG. 6, a block diagram illustrates an example of a computing device 600, through which embodiments of the disclosure can be implemented, such as (by way of non-limiting example) failure detector 208 of FIG. 2, system 400 of FIG. 4, and/or any other device described herein. The computing device 600 described herein is but one example of a suitable computing device and does not suggest any limitation on the scope of any embodiments presented. Nothing illustrated or described with respect to the computing device 600 should be interpreted as being required or as creating any type of dependency with respect to any element or plurality of elements. In various embodiments, a computing device 600 may include, but need not be limited to, failure detector 208 of FIG. 2 or system 400 of FIG. 4. In an embodiment, the computing device 600 includes at least one processor 602 and memory, such as non-volatile memory 608 and/or volatile memory 610. The computing device 600 can include one or more displays and/or output devices 604 such as monitors, speakers, headphones, projectors, wearable-displays, holographic displays, and/or printers, for example. The computing device 600 may further include one or more input devices 606 which can include, by way of example, any type of mouse, keyboard, disk/media drive, memory stick/thumb-drive, memory card, pen, touch-input device, biometric scanner, voice/auditory input device, motion-detector, camera, scale, etc.

The computing device 600 may include non-volatile memory 608, volatile memory 610, or a combination thereof. Examples of non-volatile memory 608 may include read only memory (ROM), flash memory, etc. Examples of volatile memory 610 may include random access memory (RAM), etc. A network interface 612 can facilitate communications over a network 614 via wires, via a wide area network, via a local area network, via a personal area network, via a cellular network, via a satellite network, etc. Suitable local area networks may support wired Ethernet and/or wireless technologies such as, for example, wireless fidelity (Wi-Fi). Suitable personal area networks may support wireless technologies such as, for example, IrDA, Bluetooth, Wireless USB, Z-Wave, ZigBee, NFC and/or other short distance communication protocols. Suitable personal area networks may similarly support wired computer buses such as, for example, USB and FireWire. Suitable cellular networks may support, but are not limited to, technologies such as LTE, WiMAX, UMTS, CDMA, and GSM. Network interface 612 can be communicatively coupled to any device capable of transmitting and/or receiving data via the network 614. Accordingly, the hardware of the network interface 612 can include a communication transceiver for sending and/or receiving any wired or wireless communication. For example, the network interface hardware may include an antenna, a modem, LAN port, Wi-Fi card, WiMax card, mobile communication hardware, short distance communication hardware, satellite communication hardware and/or any wired or wireless hardware for communicating with other networks and/or devices.

A computer readable storage medium 616 may include a plurality of computer readable mediums, each of which may be either a computer readable storage medium or a computer readable signal medium. A computer readable storage medium 616 may reside, for example, within an input device 606, non-volatile memory 608, volatile memory 610, or any combination thereof. A computer readable storage medium 616 can include tangible media that is able to store instructions associated with, or used by, a device or system. A computer readable storage medium 616 includes, by way of non-limiting examples: RAM, ROM, cache, fiber optics, EPROM/Flash memory, CD/DVD/BD-ROM, hard disk drives, solid-state storage, optical or magnetic storage devices, diskettes, electrical connections having a wire, or any combination thereof. A computer readable storage medium 616 may also include, for example, a system or device that is of a magnetic, optical, semiconductor, or electronic type. Computer readable storage mediums and computer readable signal mediums are mutually exclusive. For example, failure detector 208 of FIG. 2 or system 400 of FIG. 4 may utilize a computer readable storage medium to store data related to detecting a failure by a VLA model using failure detector 208 of FIG. 2 or system 400 of FIG. 4.

A computer readable signal medium can include any type of computer readable medium that is not a computer readable storage medium and may include, for example, propagated signals taking any number of forms such as optical, electromagnetic, or a combination thereof. A computer readable signal medium may include propagated data signals containing computer readable code, for example, within a carrier wave. Computer readable storage media and computer readable signal media are mutually exclusive.

The computing device 600, such as corresponding to failure detector 208 of FIG. 2 or system 400 of FIG. 4 may include one or more network interfaces 612 to facilitate communication with one or more remote devices, which may include, for example, client and/or server devices. In various embodiments, the computing device 600 may be configured to communicate over a network, such as network 614, with a server or other network computing device to transmit and receive data related to detecting a failure by a VLA model using failure detector 208 of FIG. 2 or system 400 of FIG. 4. A network interface 612 may also be described as a communications module, as these terms may be used interchangeably.

As illustrated above, various embodiments for detecting a failure by a VLA model are disclosed. It would be apparent to one of ordinary skill in the art that, while certain embodiments are described with respect to detecting a failure by a VLA model for a robot system or a vehicle control system, embodiments of the present disclosure can be used for other applications without departing from the spirit and the scope of the present disclosure. Embodiments of the present disclosure provide technical benefits and advance the state of the art in robot or other device control.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein includes systems, methods, and non-transitory computer-readable mediums for detecting a failure by a VLA model. It should also be understood that these embodiments are merely exemplary and are not intended to limit the scope of this disclosure.

What is claimed is:

1. An apparatus, comprising:
one or more processors coupled to one or more memories and configured to:
extract features from one or more layers of a vision-language-action (VLA) model;
predict a failure score by processing the features;
determine a time-varying threshold for detecting a failure by the VLA model;
detect the failure based on the failure score exceeding the time-varying threshold; and
perform an action in response to detecting the failure.

2. The apparatus of claim 1, wherein to extract the features from the one or more layers of the VLA model, the one or more processors are configured to extract the features from the last layer of the VLA model.

3. The apparatus of claim 1, wherein to predict the failure score by processing the features, the one or more processors are configured to process the features using a multi-layer perceptron (MLP).

4. The apparatus of claim 1, wherein to predict the failure score by processing the features, the one or more processors are configured to process the features using a long short-term memory (LSTM).

5. The apparatus of claim 1, wherein to predict the failure score by processing the features, the one or more processors are configured to process the features sequentially.

6. The apparatus of claim 1, wherein to determine the time-varying threshold, the one or more processors are configured to determine the time-varying threshold based on functional conformal prediction (CP) on a hold-out calibration dataset, the hold-out calibration dataset comprising data indicative of a successful action.

7. The apparatus of claim 1, wherein to perform the action in response to detecting the failure, the one or more processors are configured to:
generate a control signal associated with one or more of stopping a predicted action or backtracking from the predicted action; and
transmit the control signal to a controller.

8. The apparatus of claim 1, wherein to perform the action in response to detecting the failure, the one or more processors are configured to:
generate an alert associated with the failure; and
transmit the alert to a user interface or a user device.

9. The apparatus of claim 1, wherein to detect the failure, the one or more processors are configured to detect the failure based on a plurality of rollouts of a policy executed based on a history of observations and a language instruction specifying a desired task.

10. The apparatus of claim 1, wherein:
the VLA model comprises a generalist VLA model, and
the one or more processors are further configured to infer a predicted action, before the predicted action occurs, based on an input that is not included in a training dataset for a failure detector used for predicting the failure score, the input comprising one or more of a task not included in the training dataset or a visual input not included in the training dataset.

11. A method, comprising:
extracting features from one or more layers of a vision-language-action (VLA) model;
predicting a failure score by processing the features;
determining a time-varying threshold for detecting a failure by the VLA model;
detecting the failure based on the failure score exceeding the time-varying threshold; and
performing an action in response to detecting the failure.

12. The method of claim 11, wherein extracting the features from the one or more layers of the VLA model comprises extracting the features from the last layer of the VLA model.

13. The method of claim 11, wherein predicting the failure score by processing the features comprises processing the features using a multi-layer perceptron (MLP).

14. The method of claim 11, wherein predicting the failure score by processing the features comprises processing the features using a long short-term memory (LSTM).

15. The method of claim 11, wherein predicting the failure score by processing the features comprises processing the features sequentially.

16. The method of claim 11, wherein determining the time-varying threshold comprises determining the time-varying threshold based on functional conformal prediction (CP) on a hold-out calibration dataset, the hold-out calibration dataset comprising data indicative of a successful action.

17. The method of claim 11, wherein performing the action in response to detecting the failure comprises:
generating a control signal associated with one or more of stopping a predicted action or backtracking from the predicted action; and
transmitting the control signal to a controller.

18. The method of claim 11, wherein performing the action in response to detecting the failure comprises:
generating an alert associated with the failure; and
transmitting the alert to a user interface or a user device.

19. The method of claim 11, wherein detecting the failure comprises detecting the failure based on a plurality of rollouts executed based on a history of observations and a language instruction specifying a desired task.

20. The method of claim 11, wherein:
the VLA model comprises a generalist VLA model, and
the method further comprises inferring a predicted action, before the predicted action occurs, based on an input that is not included in a training dataset for a failure detector used for predicting the failure score, the input comprising one or more of a task not included in the training dataset or a visual input not included in the training dataset.
